(19) United States
(12) Patent Application Publication
(10) Pub. No.: US 2006/0274376 A1
(43) Pub. Date: Dec. 7, 2006

(54) Method for image background detection and removal

(75) Inventors: James R. Bailey, Shelbyville, KY (US); Bao T. Pham, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/145,802

(22) Filed: Jun. 6, 2005

(51) Int. Cl. G06K 15/00

(52) U.S. Cl. 358/3.26; 358/464

(57) ABSTRACT

A method for photocopying an original color document reduces the amount of color in the resulting photocopy. This is accomplished by scanning bands of the original document to create image bands, detecting a background color in one or more margins of the document that are within the scanned image bands, determining a stretch factor based on the color in the margins, and then scaling pixel values of the pixels by the stretch factor. The stretch factor may be established in one space, e.g., luminance space, and the scaling may be performed in another space, e.g., RGB, though this is not an absolute requirement. A device capable of performing the foregoing thereby reduces the amount of color ink or color toner consumed when the color background of an original document is not needed in the photocopy.

### CROSS REFERENCES TO RELATED APPLICATIONS

None

### STATEMENT REGARDING FEDERALLY SPONSORED RESEARCH OR DEVELOPMENT

None

### REFERENCE TO SEQUENTIAL LISTING, ETC

None

### BACKGROUND

1. Field of the Invention

The present invention relates generally to non-white or color background detection and removal for used in printers and all-in-one devices.

2. Description of the Related Art

All-in-one devices such as printer-scanner-copier products are expected to produce high quality copies at a relatively fast rate of speed. Copying text targets such as newspaper articles, receipts, etc. is a very common application for such devices. Often, such targets contain a background color or shade that gets processed along with the text contained in the target image. For example, aging newspaper becomes yellow and such a color is prevalent throughout the background of the paper. This background color/shade can significantly slow down the copy operation as this background is printed out on the resulting output copy. Printing out this background is often undesirable as it wastes ink and time. High quality copiers contain algorithms to automatically remove such background to improve not only the copy time but also the perceived output quality.

For low cost all-in-devices, the amount of available onboard memory may be less than the amount required to store an entire scanned image. To improve performance and reduce the on-board memory requirements, scanning and printing are often paralleled such that as a band of an image is scanned, it is processed and printed while the next band of image is being scanned in. The nature of the operation prevents the entire image from being analyzed to detect if a background color exists so that a substantially 100% effective background removal method can be applied to the image.

In order to decrease the amount of processing time required by the device, bands of data are often analyzed to determine if any printable data is present within the band, printable data in this context meaning data that one desires to have printed, such as text. If no such printable data is present, then nothing is printed for that band of data. A common method for determining whether any printable data exists within the band analyzes the luminance of the image data to determine if the entire band is considered whitespace. If no pixel within the band exceeds a luminance threshold, then that band is deemed to be whitespace.

One problem with this method lies in the fact that very light color shades may have very high luminance values but still be visible and thus printable. For instance, FIG. 1 shows an image 100 with a yellow-colored background 102, though with the color exaggerated so that it appears in the printed patent. If this image is copied and processed in bands and an 8-bit luminance threshold of 250 is used to determine whitespace (meaning a pixel of 250 or more is considered whitespace), then certain image bands will be detected with no printable data. Mixing incorrectly detected whitespace bands and regions with printed image data produces the image in FIG. 2. The thus-copied image looks splotchy since while portions 204 of the color background were removed, other portions of the color background 202 were not, and so certain regions of the image were incorrectly considered whitespace. The 8-bit luminance value of the yellow-colored background for this particular image is 251 based on a scale where white would have an 8-bit value of 255.

Some copier devices always “stretch” the image to a lighter shade to remove common light color backgrounds without actually attempting to detect if the target image contains a non-white or color background and what that color is. Using this technique often produces unwanted results when copying an image containing any region of light colors. Other devices use the first x-number of scan lines to detect if a background color exists. However, this technique fails to take into account if the target is placed at the top of the scanner glass, and fails if it is not.

### SUMMARY OF THE INVENTION

The present invention is directed to mitigating the effects of a non-white or color background in a page to be printed. This can be especially beneficial when copying a page with a copier or all-in-one, when the original has background color or shaded areas that should not, or need not, be reproduced in the copy. This is done by reducing the amount of a background color that appears in the final printed copy.

In one aspect, the present invention is directed to a method reducing a non-white or a color background in an image having printable data. The method comprises obtaining at least one first image band of said image, said at least one first image band being devoid of printable data; obtaining at least one second image band of said image, said at least one second image band having printable data; determining information from a background color of pixels in said at least one first image band and pixels in a lateral margin portion of said at least one second image band; and modifying pixel values in at least one third image band based on said information to reduce an amount of color of at least some pixels in the at least one third image band.

The determining and modifying steps may comprise determining a stretch factor based on the information; and scaling pixel values in the at least one third image band by said stretch factor. The stretch factor may depend on at least one peak in a histogram of pixel values that are representative of said pixels in said at least one first image band and said pixels in a lateral margin portion of said at least one second image band.

In another aspect, the present invention is directed to a method of photocopying an original document having a non-white or a color background and reducing an amount of color in a resulting photocopy. The method comprises scanning at least one band of said original document to thereby form at least one first image band, said at least one first image band being devoid of printable data; scanning at least one other band of said original document to thereby form at least one second image band, said at least one second image band having printable data; determining information from a background color of pixels in said at least one first image band and pixels in a lateral margin portion of said at least one second image band; and modifying pixel values in at least one third image band based on said information to reduce an amount of color in the resulting photocopy.

In yet another aspect, the present invention is directed to a device capable of photocopying an original document having a color background and reducing an amount of color in a resulting photocopy. The device is configured, in a particular operator-selected mode, to scan at least one band of said original document to thereby form at least one first image band, said at least one first image band being devoid of printable data; scan at least one other band of said original document to thereby form at least one second image band, said at least one second image band having printable data; determine information from a background color of pixels in said at least one first image band and pixels in a lateral margin portion of said at least one second image band; and modify pixel values in at least one third image band based on said information to reduce an amount of color in the resulting photocopy.

The device may further be configured to determine a stretch factor based on the information; and scale pixel values in the at least one third image band by said stretch factor. The device may further be configured to determine at least one peak in a histogram of pixel values that are representative of said pixels in said at least one first image band and said pixels in a lateral margin portion of said at least one second image band, to determine said stretch factor.

### BRIEF DESCRIPTION OF THE DRAWINGS

The patent or application file contains at least one drawing executed in color. Copies of the patent or patent application publication with color drawings(s) will be provided by the Office upon request and payment of the necessary fee.

FIG. 1 shows an exemplary image scanned from a document have a color background;

FIG. 2 shows the results of a prior art method for removing a color background in the image of FIG. 1;

FIG. 3 depicts the regions of a scanned image of a document having a color background;

FIG. 4 shows hypothetical image bands in the scanned image of FIG. 3;

FIG. 5 shows a detailed portion of FIG. 4 where pixels for a histogram are taken in accordance with one embodiment of the present invention;

FIG. 6 is an exemplary histogram showing a detected peak value;

FIG. 7 shows the results of using one embodiment of the present invention on the image seen in FIG. 1;

FIG. 8a shows a simplified flow chart of one embodiment in accordance with the present invention;

FIG. 8b shows a detailed implementation of the embodiment of FIG. 8a;

FIG. 9a shows a simplified flow chart of another embodiment in accordance with the present invention;

FIG. 9b shows a detailed implementation of the embodiment of FIG. 9a;

FIG. 10 illustrates a scanned image overlaid onto a grid, with an enlarged area showing exemplary counts of different types of pixels in some of the grid regions;

FIG. 11 is a flow diagram of a method for counting pixels of different types of categories; and

FIG. 12 is a flow diagram of a method for detecting a left margin of an image band.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The term output as used herein encompasses output from any printing device such as color copier, color printers, and so-called color “all-in-one devices” that incorporate multiple functions such as scanning, copying, and printing capabilities in one device. Such printing devices may utilize ink jet, dot matrix, dye sublimation, laser, and any other suitable print formats. The term button as used herein means any component, whether a physical component or graphic user interface icon, that is engaged to initiate output.

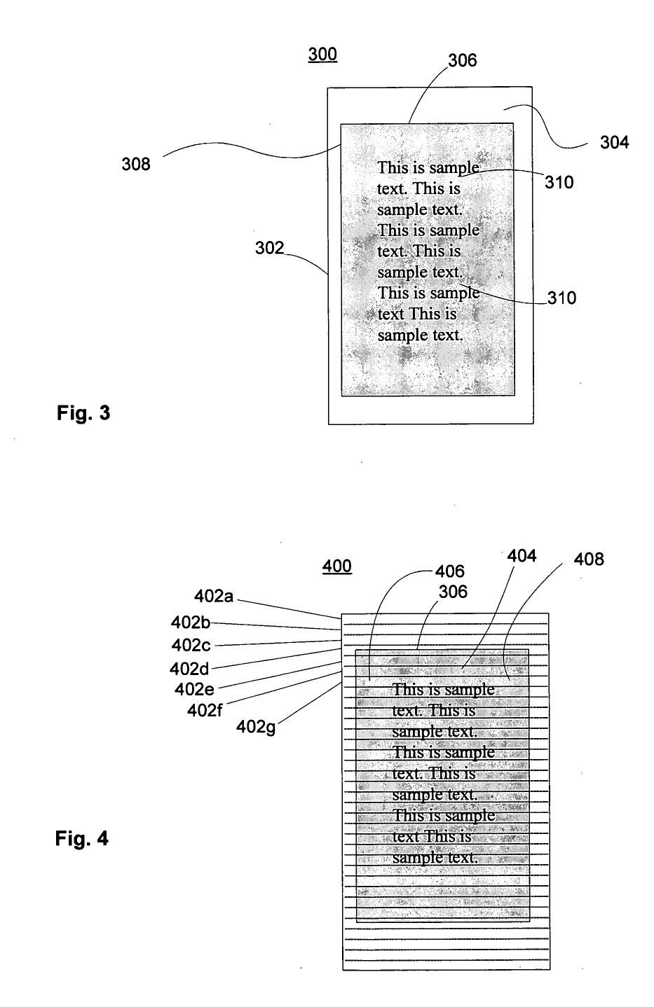

FIG. 3 shows scanned image 300 from a flatbed scanner belonging to a color photocopier, a color all-in-one device, or the like. The scanner target area 302 encompasses both the cover color 304 (usually white) found on the underside of the scanner cover, and the document 306. The document 306 has a background color 308 and text 310, the latter being surrounded by a document margin comprising the background color. It is desirable to print the text 310 in the photocopy, but not the background color 308.

Devices in which scanning and printing are performed in parallel may have a controller ASIC with limited onboard memory. In such a device, it may not be possible to store an entire image at one time in that memory. Therefore, the image will be scanned and processed in horizontal image bands of data, with only a few such image bands being available for analysis at any given time during a photocopy operation.

Some of these image bands may only comprise cover color, while others will contain both cover color and document. In those image bands where document is present, some image bands may have only a background color while other image bands will have both document background color and text. FIG. 4 depicts an image 400 scanned into image bands and shows hypothetical image bands juxtaposed over the scanned image of FIG. 3. The first several image bands in FIG. 4 are designated by reference numerals 402a-402g. Of these, a first set of image bands, the ones at the “top” of the image and comprising image bands 402a, 402b and 402c, have cover color only. A second set of image bands, namely image bands 402d, 402e, 402f, and 402g, have both cover color and document. Within this second set are a third set of image bands comprising only those image bands (402d, 402e) that are devoid of printable data, and also a fourth set of image bands comprising only those image bands (402f, 402g) that include printable data. It is understood that additional image bands, not designated by reference numerals in FIG. 4, will subsequently be scanned.

As also seen in FIG. 4, the document margin portion of the document 306 includes a document top margin 404 that appears above the first printable-data-containing image band 402f, a document left margin 406 that appears to the left of the text, and a document right margin 408 that appears to the right of the text. It can be seen from FIG. 4 that each of these document margins may be present in more than one image band, and so each image band may have document margin portions belonging to a larger document margin (top, left or right) of the document. In the case of FIG. 4, image bands 402d and 402e each have document margin portions that belong to the document top margin 404, while image bands 402f and 402g have document left and document right margin portions that belong to left and right document margins 406, 408, respectively. In addition, however, image bands 402d, 402e, 402f and 402g all have cover margin portions located on either side of the document portion within each such image band.

For convenience, we will simply refer to “margin portion” when referring to both the document margin portion and the cover margin portion. It is understood that there sometimes may not be any cover margin portion, in which case the term “margin portion” would simply refer to the document margin alone. Also for convenience, we will use the term “lateral margin portion” when referring to either a left margin portion or a right margin portion, or both. Thus, an image band containing printable data, such as image bands 402f, 402g, comprises a “printable data portion” (e.g., text in these image bands) bordered on one or both sides by a lateral margin portion.

The color of the scanner cover is known. Therefore, scanning portions of the scanner cover creates pixel data whose luminance, chrominance and/or other pixel characteristics are well understood for that device. It is further understood that, in some instances, the scanned document may not have been perfectly aligned relative to the edges of the scanner area, and so the border of the document may be angled or skewed relative to the scanner area, thus resulting in cover color pixel areas whose width varies along the length of the scanned document. This, too, is managed by virtue of the well-understood characteristics of the cover color pixel data, as is known to those skilled in the art.

Thus, in accordance with the present invention, for the document 306, the first set of image bands comprising images bands 402a, 402, 402c will contain cover color only. These bands will be correctly labeled whitespace to prevent further unnecessary image processing. Image bands 402d and 402e contain image data from the top margin of the document but contain none of the text contained in the image. These bands 402d, 402e contain only the background color of the target image along with the whitespace margins of the scanner target area, and are devoid of printable data. The image band 402f is the first image band to contain any portions of text characters at all.

In one embodiment, a predetermined luminance threshold is used to decide if a pixel within an image band is either whitespace or contains a light enough background to be removed. For example, an 8-bit luminance value of 250 or above will represent a very light shade of color or possibly pure white. If an image band is detected to have a certain percentage of pixels at or above this luminance value, then this band is considered to be whitespace/removable background. For example, if a band of data contains 99% of pixels above 250 luminance, then that band is not processed further but instead marked as whitespace/removable background. For the example in FIG. 4, image bands 402a, 402b, 402c, 402d and 402e will be detected as such and nothing will be printed for these image bands during a copy operation.

Image bands 402f and 402g contain printable text and will be detected as a printable image band. However, the background color must be detected and removed in order to create an optimal copy output. Failure to properly detect and remove the background will result in the top part of the copy, image bands 402a, 402b and 402c containing only whitespace with the rest of the copy containing the colored background, provided that such colored background is present throughout the text.

In one embodiment, a full histogram of the last detected whitespace/removable background image band is performed to detect any color peaks, which indicate that a color background exists. As discussed further below, the luminance value corresponding to such a color peak is then used to develop a stretch factor for modifying pixel values to be printed.

In another embodiment, pixels in the lateral margin portion of the first printable-data-containing image band are detected and histogrammed in order to determine the color of the detected background. For this, the coordinates of where printable data begins and ends for that first printable-data-containing image band are determined. Pixels in that image band outside these coordinates are then histogrammed in order to detect the image background.

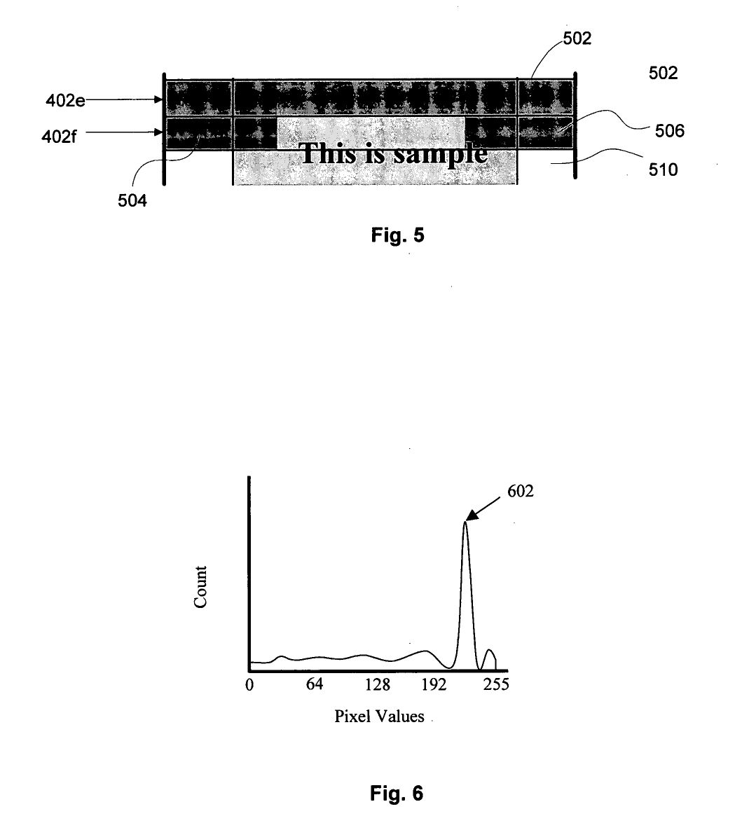

In yet another embodiment, pixels in both the last detected whitespace/removable background image band and pixels in the lateral margin portion of the first printable-data-containing image band are histogrammed together. FIG. 5 shows a portion of FIG. 4, indicating the region that is histogrammed in this embodiment. As seen in FIG. 5, pixels in the darkly shaded region 502, which comprises the entire image band 402e (the last detected whitespace/removable background image band), the left margin portion 504 (which includes both cover left and document left margin portions) and right margin portion 506 (which includes both cover right and document right margin portions) of the first printable-data-containing image band, are used in the histogram.

Information about the background color, or “background detection”, is used in the present invention. In particular, this information is used to modify at least some pixel values so as to reduce an amount of color in the printed output. In one embodiment, this information is obtained from histogramming and peak detection.

Generally speaking, histogramming is performed on pixel values that are representative of pixels in one or more image bands. Thus, the histogramming can take place in one of a number of spaces, e.g., the RGB space, luminance space, chrominance space, and in other spaces, as well.

Peak detection can also be performed in a number of ways. In a preferred embodiment, a peak is defined as follows. If the total number of pixels M between a pixel value x and a pixel value x+Δis greater than the total number of pixels N in β% of the histogrammed portion of the image, then the background peak is taken to be the pixel value with the largest count between x and x+Δ, where Δ is a range that represents the width of the curve containing the peak in the histogram. A range Δ is preferred because the background color usually is not limited to a single value (regardless of which space one uses), but rather to a small range of similar values. β is the minimum percentage of the pixels in the histogrammed image required to be found within the specified range, for the range to encompass a peak, and thus signify a background. β is typically a high percentage value since a background should comprise of most of the histogrammed portion of the image. In a preferred embodiment, however, since we are histogramming margins of the first printable-data-containing image band, and the immediately preceding image band (which is devoid of printable data), a β on the order of 95% or so may be used, since there is no printable data in these regions.

FIG. 6 presents an exemplary histogram of 6,500 pixels of an image. In this example, Δ=10 so as to create a nominal range within which a background peak may reside. 5,000 pixels are detected between pixel values of x=230 and x=240 (x+10). Therefore, x=230. If β=75%, then 5,000/6,500=76.9%, which is greater than β. Therefore, a background peak has been detected. The largest count between 230 and 240 is 235 and so, in this example, the peak 602 for the background color is deemed to have a detected peak pixel value of 235.

Another requirement that may be placed on background detection is that it must be greater than a certain pixel value to ensure it is not a really dark background that would be very destructive to remove. For example, a value of 200 can be used such that only peak values greater than 200 are determined to be light enough to be considered a removal background color/shade. In the example of FIG. 6, the pixel value of 235 is greater than 200 and so still would qualify as a background color under this criterion.

Given a detected peak value, every pixel can then be modified based on information derived from the detected peak value so as to reduce an amount of color. In one embodiment, the modification calls for each pixel value to be transformed by a stretch factor. In one embodiment the stretch factor is given by the following Equation 1:
Output_Pixel_Value=Input_Pixel_Value*Stretch_Factor1
where Stretch_Factor1=255/Detected_Peak_Value. Equation 1

Thus, in the case of FIG. 6 where the detected peak value is 235, the stretch factor Stretch_Factor1 is 255/235=1.0851063, it being understood that decimal portions of the resulting output pixel value may be rounded or truncated, as desired. Equation 1 allows one to “scale” or “stretch” all pixel values such that input pixel values near the detected peak are mapped onto an output pixel value of approximately 255. It is understood in this embodiment that the histogramming is performed with the pixel values ranging from 0-255 and so the detected peak is also in this range and the stretch factor uses the value of 255 in the numerator. It is further understood that if histogramming is done using some other range, say, with a different maximum value, that that maximum value would be used in the numerator.

When implemented in an ASIC in which operations are performed in integer arithmetic, a slightly different algorithm may be used to take advantage of enhanced numeric precision. In such case, Equation 1 may be written as Equation 2:

$$Output\_Pixel \_Value = \frac{\begin{matrix}Input\_Pixel \_Value * \\ Stretch\_Factor 2\end{matrix}}{128} \\ where \\ Stretch\_Factor 2 = \frac{255 * 128}{Detected\_Peak \_Value} \qquad Equation 2$$

Thus, in the case of FIG. 6 where the detected peak value is 235, the stretch factor Stretch_Factor2 is 255* 128/235=139 (after rounding/truncation).

It is also understood that the histogramming/peak detection may be conducted in one space while the pixel scaling is conducted in another space. It is likewise possible to conduct both the histogramming/peak detection and the scaling in the same space.

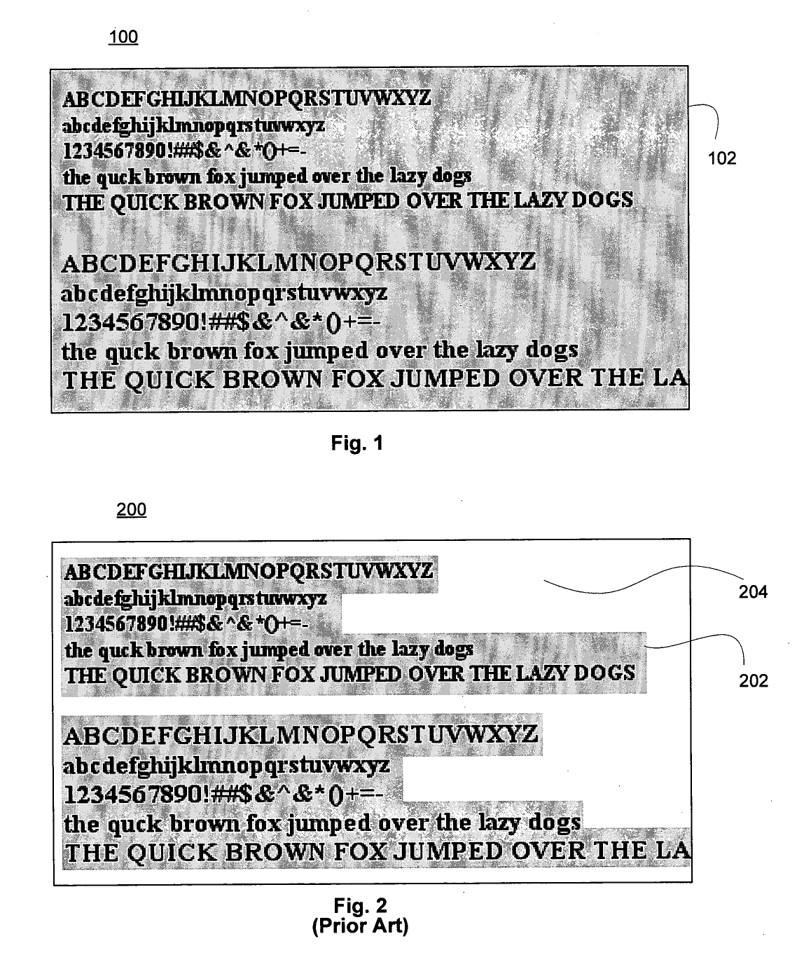

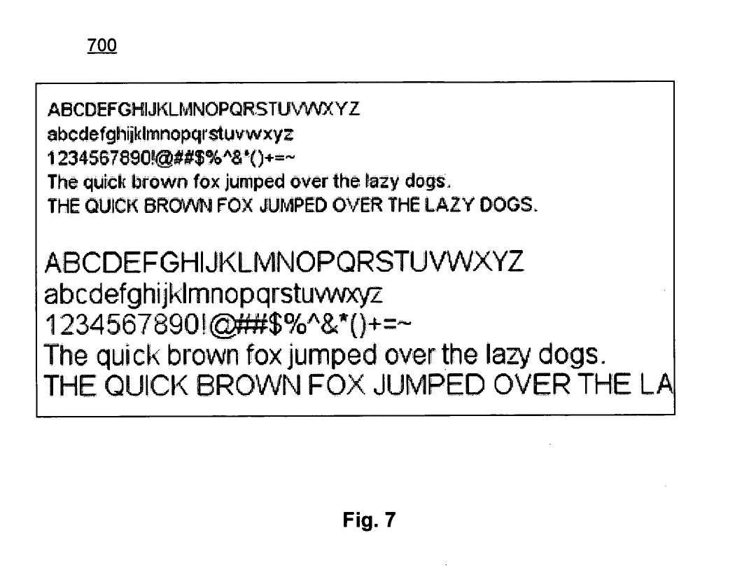

In an example using an image of the sort seen in FIG. 1, the RGB values of pixels in the last detected whitespace/removable background image band and margin portions of the first printable-data-containing image band were separately histogrammed. This resulted in a determination that the red and green channels both had peaks at 255 while the blue channel had a peak at 220. Therefore, it was deduced that there was a background of color (255, 255, 220) in the image. This information was then used to determine a stretch factor using Equation 2 above. Specifically, a stretch factor of 255*128/220=148 was formed and this was used to stretch the RGB pixel values, resulting in the removal of color in the output image 700, as seen in FIG. 7.

Generally speaking, a stretch factor determined from pixels in a first set of image bands may be used to stretch pixels belonging to a second set of image bands. It is understood that the second set of image bands may be the same as the first set of image bands—in other words, the pixels that are stretched are the same as some of those used to create the stretch factor.

Alternatively, or in addition, the second set of image bands are completely different from the first set of image bands. Thus, the stretch factor is used to stretch pixels belonging to future image bands, i.e., image bands that have not yet been formed because their underlying data has yet to be scanned in the scan-while-printing process. In such case, in one embodiment, once a stretch factor is determined, it may be used for all image bands without further modification. In another embodiment, the stretch factor may be dynamically changed, perhaps using only the most recent margin information, a feature which can be beneficial in the case of a background color that changes along the length of a document.

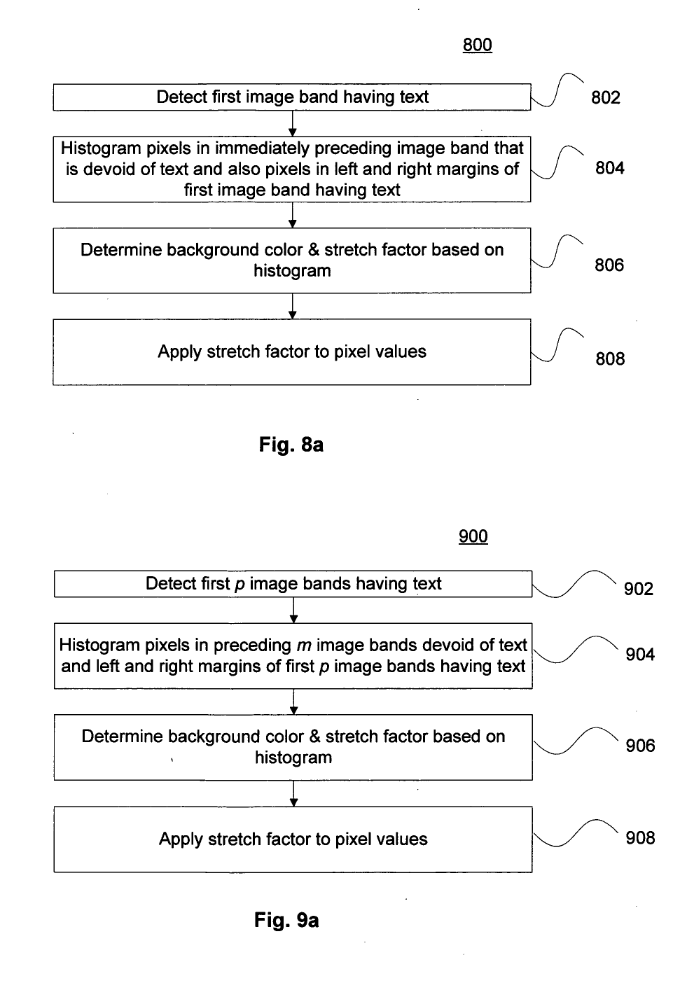

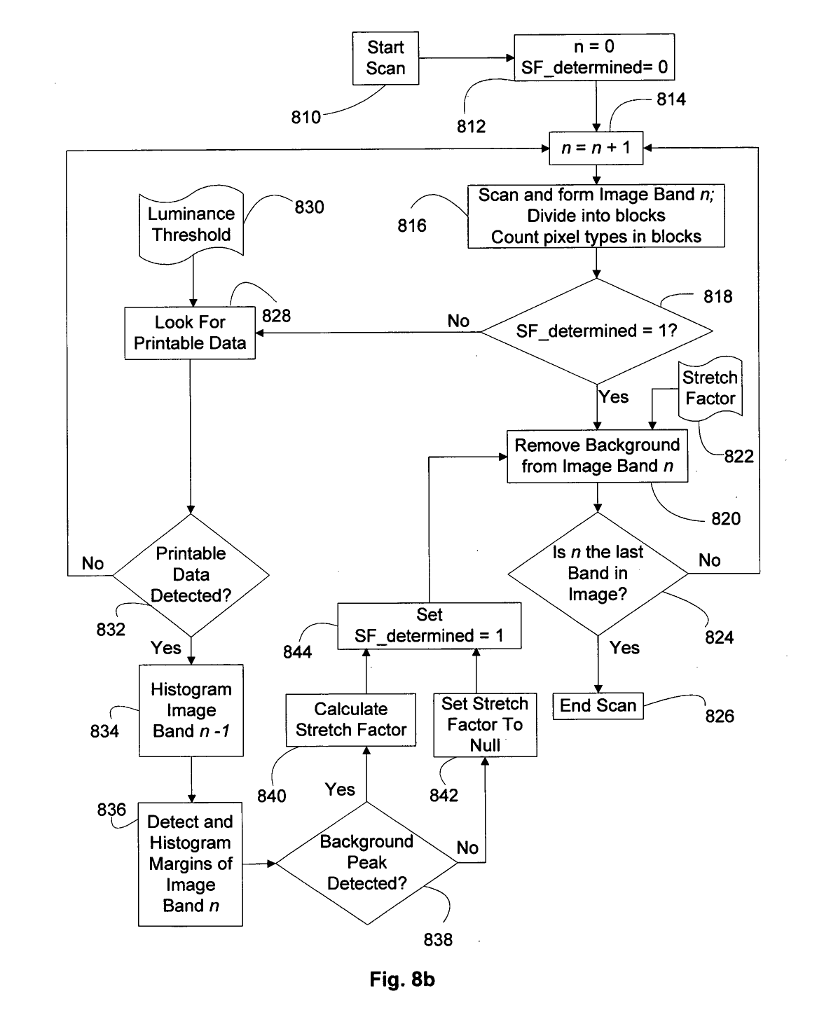

FIG. 8a presents the overall method of one embodiment of the invention in the form of a flowchart 800. In this embodiment, the pixels in the margin portions of the first printable-data-containing image band, and the pixels in the immediately preceding image band that is devoid of printable data, i.e., the last image band with only whitespace/removable background color, are used in the histogramming process. In step 802, the first image band containing text that one wishes to print is detected. Then, in step 804, a histogram is performed on the pixels in the immediately preceding image band that is devoid of printable data and the pixels in the lateral margin portion of the first printable-data-containing image band. Based on the information in these two image bands, as represented by the histogram, a background color and thus a stretch factor are determined in step 806. Finally, in step 808, the stretch factor is applied to the pixels.

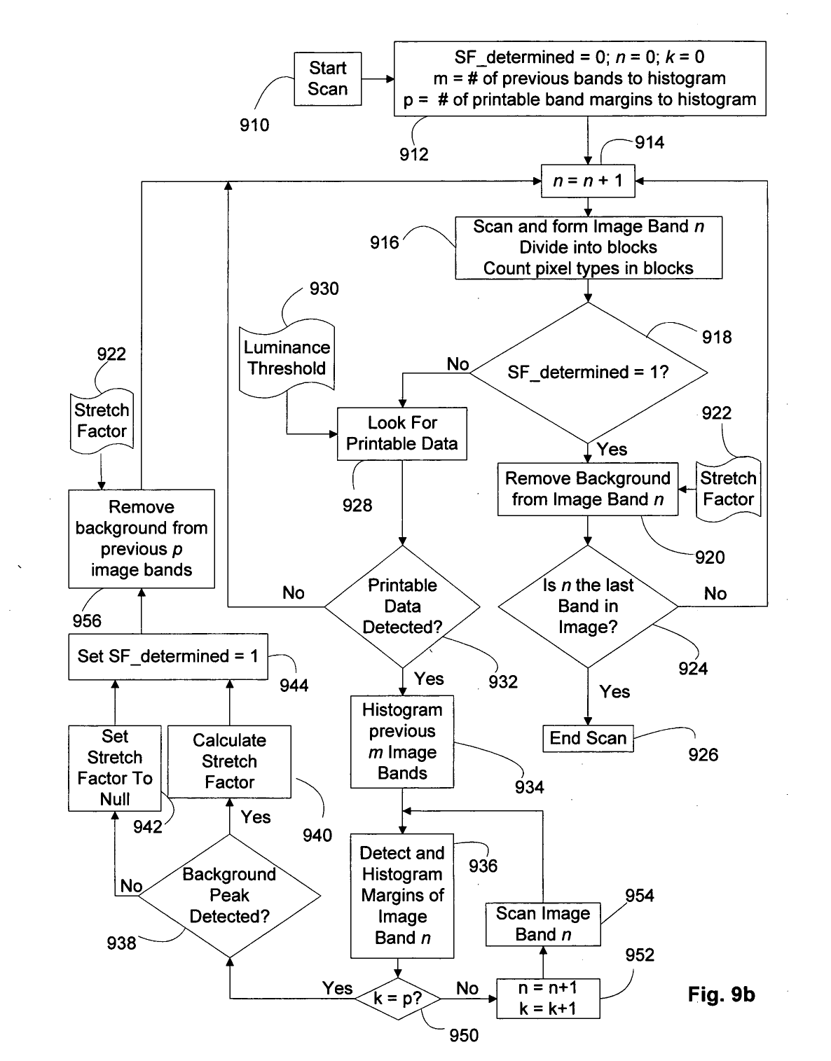

FIG. 9a presents the overall method of another embodiment of the invention in the form of a flowchart 900. In this embodiment, the pixels in the margin portions of the first p printable-data-containing image bands, and the pixels in the preceding m image bands that are devoid of printable data, are used in the histogramming process. In step 902, the first p image bands containing text that one wishes to print is detected. Then, in step 904, a histogram is performed on the pixels in the preceding m image bands that are devoid of printable data and the pixels in the lateral margin portion of the first p printable-data-containing image bands. Based on the information in these m+p image bands, as represented by the histogram, a background color, and thus a stretch factor, are determined in step 906. Finally, in step 908, the stretch factor is applied to the pixels.

FIG. 8b presents a detailed block-diagram illustrating the processes of one implementation of the method described with respect to FIG. 8a. At block 810, the scan is started. At this time, as seen in block 812, an “image band” counter n is set to 0. In addition, a flag “SF_determined”, which indicates whether a stretch factor has been determined, is set to false (i.e., to 0).

At block 814, the counter n is incremented, to indicate that a first image band is about to be formed. A block 816, a scan is performed and image band n is formed.

A grid conceptually overlays the image band, dividing the latter into equal-size blocks. In one embodiment, the width of the image is divided into 32 columns. For a 600 dpi image that is 9 inches wide, or total of 5400 pixels in all, each column has a width of approximately 168 pixels. The image band height is on the order of 16 pixels and so each block contains roughly 2700 pixels. The pixels, which have been scanned into RGB channels are then converted, etc. into other spaces, such as luminance, chrominance, L*a*b, etc. for further processing to categorize each pixel into one of a plurality of types. In one embodiment, each pixel is classified as belonging to one of four groups: gray, white, black or color, and the number of pixels in each such group is determined for each block. This information may be used later on to help identify background color potions, cover color portion, margins and the like.

At block 818, a check is made to see whether the flag SF_determined has been set. If a stretch factor has previously been determined, then in block 820, the stretch factor 822 is used to help remove the background color from image band n. In block 824, a check is made to see if this is the last image band. If this is last image band, then in block 826, the process is stopped. If this is not the last image band, then control goes to block 814 to continue with the next image band.

If, at block, 818, if is determined that a stretch factor has not previously been determined, then in block 828 a process is commenced to determine whether printable data has been found thus far and, more particularly, in image band n, as represented by the information elicited in block 816. This process makes use of a luminance threshold 830, low luminance values being indicative of printable data, such as text and the like that one desires to print. In block 832, a determination is made whether printable data is found in image band n. If no printable data is detected, then control goes block 814 to process the next image band in a search for the first sign of printable data.

If, in block 832, it is determined that printable data has finally been found, then in block 834, the pixels in the immediately preceding image band (which is devoid of such printable data) are histogrammed. In block 836, the pixels in the margin portions of the current image band are determined based on the information elicited at block 816, and these pixels are then included in this histogram.

Next, in block 838, a determination is made whether there is a background peak in the histogram. If so, in block 840, a stretch factor is calculated. If not, in block, 842, the stretch factor is set to NULL, i.e., it is set to a value reflective of no scaling, which most often is simply equivalent to a detected peak value of 255. It can thus be seen that the stretch factor depends on at least one peak in a histogram of pixel values that are representative of pixels in both an image band devoid of printable text and an image band containing printable text. Whether or not a background peak has been detected, the flag SF_determined is set to true (or ‘1’) in block 844 to indicate that printable data has been found and so the algorithm may henceforth stretch the pixel values to mitigate the effects of background color. Control then passes to block 820 to perform the stretching and continue with any further image bands. As previously described but not shown in FIG. 8b, the flag SF_determined can also be reset after a predetermined number of bands are scanned allowing for a new histogram to be performed such as where the background color may change as the image is scanned.

FIG. 9b presents a detailed block-diagram illustrating the processes of one implementation of the method described with respect to FIG. 9a. At block 910, the scan is started. At this time, as seen in block 912, an “image band” counter n is set to 0 as is a “number of printable-data-containing image bands found” counter k is also set to 0. In addition, a flag “SF_determined”, which indicates whether a stretch factor has been determined, is set to false (i.e., to 0). In FIG. 9b, the value “m” designates the number of previous image bands devoid of printable data that should be histogrammed, and the value “p” designates the number of image bands having printable data whose margin portions should also be included in the histogram.

In FIG. 9b, blocks 914, 916, 918, 920, 922, 924, 926, 928, 930 and 932 behave substantially the same as their counterparts in FIG. 8b having reference numerals 100 less in value, and so are not described in further detail.

If, in block 932, it is determined that printable data has finally been found, then in block 934, the pixels in the immediately preceding m image bands (all of which are devoid of such printable data) are histogrammed. In block 936, the pixels in the margin portions of the current image band are determined based on the information elicited at block 916, and these pixels are then included in this histogram.

However, since it is desired that a total of p printable-data-containing image bands be used, in block 950, a determination is made to see whether the “number of printable-data-containing image bands found” counter k has reached the value p. If not, in block 952, the image band counter n and the counter k are incremented. Then, in block 954 the next image band (which presumably also is a printable-data-containing image band) is formed and control goes back to block 936 where the margin portions from this new image band are also included in the histogram. This continues until the requisite number p printable-data-containing image bands have been formed and their appropriate pixels incorporated into the histogram.

If, in block 950, it is determined that the requisite number p printable-data-containing image bands have been found, and the histogram completed, control goes to block 938 to determine whether there is a background peak in the histogram. If so, in block 940, a stretch factor is calculated. If not, in block, 942, the stretch factor is set to NULL, i.e., it is set to a value reflective of no scaling, which most often is simply equivalent to a detected peak value of 255. Whether or not a background peak has been detected, the flag SF_determined is set to true (or ‘1’) in block 944, to indicate that printable data has been found and so the algorithm may henceforth stretch the pixel values to mitigate the effects of background color. Control then passes to block 956 to remove the background from the last p printable-data-containing image bands using the recently determined stretch factor, after which control goes to block 914 to continue with stretching the remaining image bands.

It is particularly noted that in FIGS. 8b and 9b, no provision is made for removing background color until printable data is first found. This is because until printable data has been found, nothing is printed at all and so no scaling of pixel values is required. It is further noted that in these embodiments, no stretch factor is established until such time as printable data has been found. It should be kept in mind, however that, in other embodiments, a stretch factor may be based on the background color determined from a top margin alone, prior to finding any printable-data-containing image bands.

The process for partitioning an image band into blocks and counting pixel types in each block, as described above with respect to blocks 816, 916 in FIGS. 8b, 9b, respectively, is next discussed.

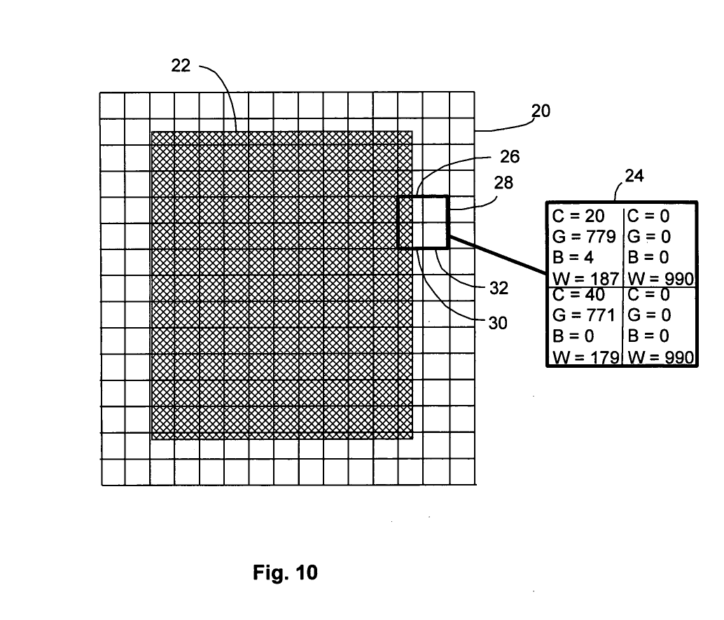

As illustrated in FIG. 10, in the general case of an entire image of a scanned document, the data may comprise a rectangular region 20 of pixels. A rectangular grid conceptually overlaid upon this region defines rectangular grid spaces or sub-regions of pixels. The scanned image data comprises regions of white or mostly white pixels bordering one or more regions of printable data, such as text, graphics or other content, indicated in FIG. 10 by the shaded content region 22. These bordering regions generally represent the margins of the scanned document, the border created by a scanner cover color being ignored in this example. The inset 24 illustrates the content within an exemplary four mutually adjacent spaces or sub-regions 26, 28, 30 and 32. In the illustrated example, sub-region 26 consists of the following quantities or counts of pixels of the following types or categories: 20 color (“C”) pixels, 779 gray (“G”) pixels, four black (“B”) pixels, and 187 white (“W”) pixels. Similarly, sub-region 28 consists of: zero color pixels, zero gray pixels, zero black pixels and 990 white pixels. Note that it can be inferred that the image has a margin bordering on sub-regions 28 and 32 because the number of non-white pixels in sub-regions 26 and 30 are sharply greater than the number of non-white pixels in adjacent sub-regions 28 and 32, respectively. The significance of such an inference is described in further detail below.

When a single image band is formed, the corresponding pixel data is received from a scanning device and stored in memory. The image band is divided in blocks using a conceptually defined grid which is typically implemented by any of a number of memory addressing or indexing schemes that will occur readily to persons skilled in the art. The number of pixels of each of a number of pixel categories within each sub-region is counted. For example, in some embodiments, there can be the following four categories or a subset thereof: color pixels, gray pixels, black pixels and white pixels. In an embodiment in which these four categories are counted, in each sub-region, the number of color pixels is counted, the number of gray pixels is counted, the number of black pixels is counted, and the number of white pixels is counted. In some embodiments, the categories can include white pixels and non-white pixels. Gray pixels and color pixels are examples of non-white pixels. These teachings and examples will lead persons skilled in the art to consider still other pixel categories that may be useful.

Once the pixel counts have been completed, they may be compared to one or more pixel distributions. A pixel distribution characterizes a group of one or more sub-regions as having the characteristics of a certain type of content, such as whitespace, text, graphics, non-whitespace (i.e., text, graphics-anything but whitespace), etc. For example, the existence of a sub-region or group of several adjacent sub-regions in which the great majority of pixels are white is characteristic of a margin area of a document or other whitespace. Thus, a corresponding distribution can be defined in which the number or, equivalently, percentage of white pixels exceeds some predetermined threshold value. Detecting the type of content an image contains and its location within the image band may provide a basis for performing further image processing operations tailored to the content type. For example, it is desirable to detect where on the document image the left and right margins are located. As another example, it may be desirable to detect where on the document image a region of text borders a region of graphics, or where a region of whitespace bordering regions of text indicates a gap between columns of text. It will be apparent to persons skilled in the art that much can be inferred by knowing the locations of various types of content on a document image.

The pixel distribution can be defined mathematically or algorithmically in any suitable manner. The term “distribution” is used for convenience in this patent specification and is not intended to imply any specific mathematical or algorithmic concept. In the illustrated embodiment, a distribution can be defined by a set of upper and lower threshold values against which the counts or percentages of pixels in the various categories are compared. A characterization can then be made based upon or in response to the comparison of the counts or percentages of pixels in each category with the distribution or distributions. Thus, for example, if the counts or percentages fit a distribution associated with whitespace, the group is characterized as whitespace.

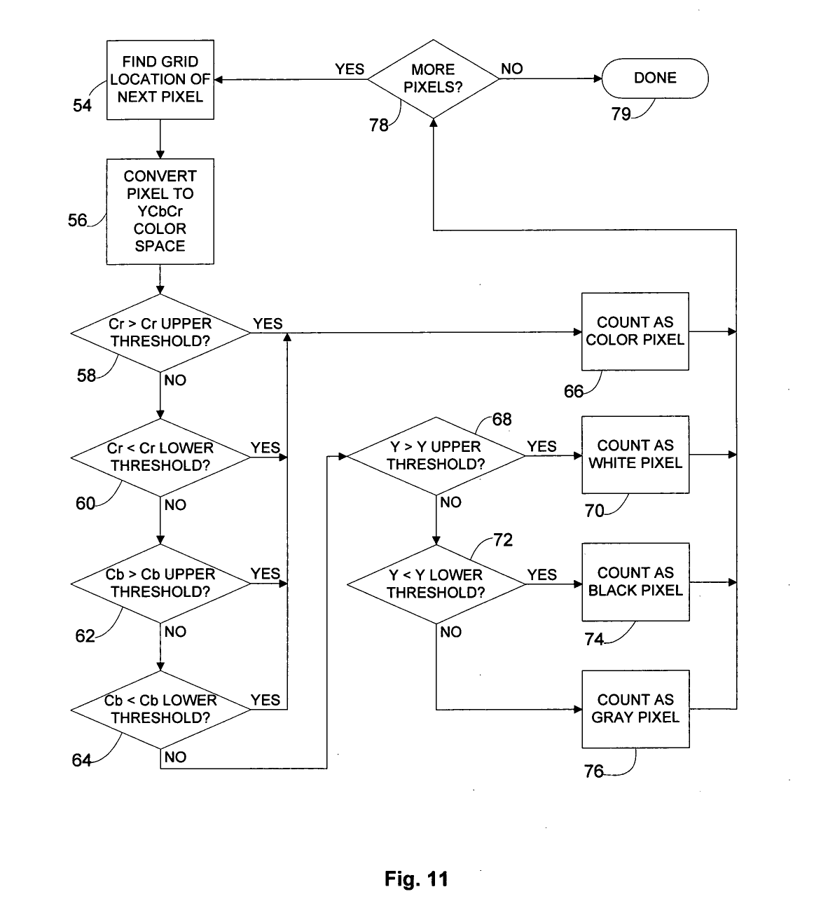

The step of counting pixels of the various categories in each sub-region is illustrated in further detail in FIG. 11. Pixels are processed in any suitable sequence, such as a raster-scan sequence, or on a grid-space by grid-space basis. At step 54, the next pixel in the sequence is processed by determining the grid space, also referred to herein as a sub-region, in which the pixel is located. In one embodiment, if the value of the pixel is stored in RGB or some color space format other than YCrCb, it is converted to YCrCb color space at step 56. The formula for performing this conversion is a well-known international standard, ITU-R BT.601 (formerly CCIR 601), known to those skilled in the art. In other embodiments, the steps seen in FIG. 11 may be performed in other color spaces, and so in some instances conversion may not be necessary.

In FIG. 11, at step 58, it is determined whether the chrominance-red (Cr) value of the pixel is greater than some predetermined upper threshold value. If it is not, then at step 60 it is it is determined whether the Cr value of the pixel is less than or equal to some predetermined lower threshold value. If it is not, then at step 62 it is determined whether the chrominance-blue (Cb) value of the pixel is greater than some predetermined upper threshold value. If it is not, then at step 64 it is determined whether the Cb value of the pixel is less than some predetermined lower threshold value. If any of these are true, then the pixel is counted as a color pixel at step 66 and not as gray, black or white. If none of these are true, then at step 68 it is determined whether the luminance (Y) value of the pixel is greater than some predetermined upper threshold. If it is, then it is counted as a white pixel at step 70. If it is not, then at step 72 it is determined whether the Y value of the pixel is less than some predetermined lower threshold value. If it is, then it is counted as a black pixel at step 74. If it is not, then it is counted as a gray pixel at step 76. After the pixel is counted, then at step 78 it is determined whether there are more pixels in the sequence to process. If there are, the process continues with the next pixel at step 54. Otherwise, the process of counting the pixels in each category is completed at 79. When completed, each sub-region has a corresponding count of the number of pixels in each category, i.e., black, white, gray and color.

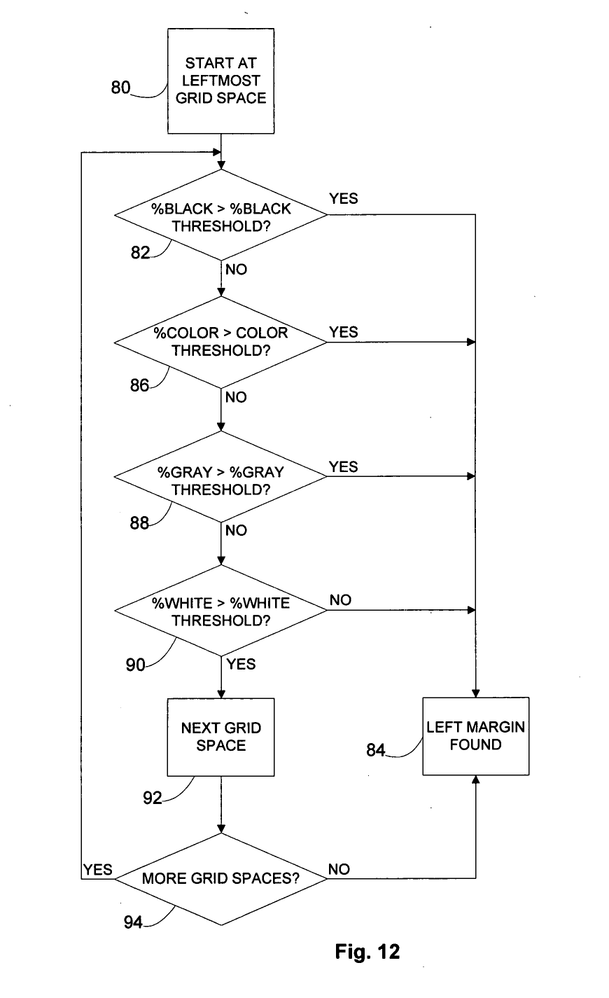

A method for detecting a margin within an image band, as called for in blocks 836, 936 of FIGS. 8b, 9b, respectively, is next described in FIG. 12, using the detection of a left margin as an example.

At step 80 the method begins at the leftmost grid space, or sub-region, of the image band. At step 82, it is determined whether the percentage of black pixels in that sub-region (i.e., the number of black pixels divided by the total number of pixels) is greater than some predetermined threshold value. The margin is assumed to be mostly white or colored. Therefore, if the percentage is greater, the left margin has been found, as indicated by step 84. If the percentage is not greater, then it is determined whether the percentage of color pixels in that sub-region is greater than some predetermined threshold. If the percentage is greater, the left margin has been found, as indicated by step 84. Similarly, if it is not greater, then at step 88 it is determined whether the percentage of gray pixels in that sub-region is greater than some predetermined threshold. If the percentage is greater, the left margin has been found, as indicated by step 84. If it is not greater, then at step 90 it is determined whether the percentage of white pixels in that sub-region is greater than some predetermined threshold. If the percentage is greater, then the left margin has not been found and, as indicated by step 92, the process continues with the next leftmost sub-region until at step 94 it is determined that there are no more sub-regions, i.e., the rightmost sub-region has been processed. If the percentage of white pixels is not greater than the predetermined threshold percentage, or if no more sub-regions exist in the band, then the left margin has been found, as indicated by step 84. Selecting suitable threshold percentages is well-within the capabilities of the person of skill in the art, but by way of example, in some embodiments of the invention, a sub-region can be characterized as margin or whitespace if it has more than 99% white pixels because the remaining one percent of non-white pixels is sufficiently small to be considered noise. Determining a right margin proceeds in a similar manner.

One skilled in the art will readily recognize that a device contemplated herein, such as a color copier or a color all-in-one, will include at least a scanner, a printer, a processor and memory. It is further contemplated that such a device may have either a graphical user interface or a control panel provided with one or more buttons to invoke or otherwise control one or more features of the present invention. Thus, in some embodiments, the present invention operates only in a particular, operator-selected mode of the device, and so an operator may be required to deliberately select the foregoing background-color-removing feature each time a photocopy is required. In other embodiments, the device may be configured to use background-color-removing feature as the default, with an operator being require to deselect this feature.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of reducing color background in an image having printable data, the method comprising:
obtaining at least one first image band of said image, said at least one first image band being devoid of printable data;
obtaining at least one second image band of said image, said at least one second image band having printable data;
determining information from a background color of pixels in said at least one first image band and pixels in a lateral margin portion of said at least one second image band; and
modifying pixel values in at least one third image band based on said information to reduce an amount of said background color of at least some pixels in the at least one third image band.

2. The method according to claim 1, wherein the at least one first image band immediately precedes the at least one second image band within the image.

3. The method according to claim 1, wherein the lateral margin portion includes both a left margin portion appearing to the left of printable data and a right margin portion appearing to the right of printable data, within the at least one second image band.

4. The method according to claim 1, wherein the determining and modifying steps comprise:
determining a stretch factor based on the information; and
scaling pixel values in the at least one third image band by said stretch factor.

5. The method according to claim 4, wherein the stretch factor depends on at least one peak in a histogram of pixel values that are representative of said pixels in said at least one first image band and said pixels in a lateral margin portion of said at least one second image band.

6. The method according to claim 5, wherein,
for 8-bit pixel values, the stretch factor SF is given by:
SF=255/P_{d},
where P_{d} is a detected peak value in said histogram.

7. The method according to claim 1, comprising:
modifying pixel values of all pixels in said at least one third image band.

8. The method according to claim 7, comprising:
printing all pixels in said at least one third image band, after their pixel values have been modified.

9. The method according to claim 1, comprising modifying RGB pixel values.

10. The method according to claim 1, comprising modifying luminance pixel values.

11. The method according to claim 1, comprising modifying chrominance pixel value.

12. The method according to claim 1, comprising:
obtaining a number p second image bands,p>1;
using pixels in a lateral margin portion of each of the p second image bands to determine said information; and
modifying pixels in said p second image bands.

13. The method according to claim 1, comprising:
obtaining a number m first image bands, m>1;
obtaining a number p second image bands, p>1; and
using pixels in all m first image bands and pixels in a lateral margin portion of each of the p second image bands to determine said information; and
modifying pixels in said p second image bands.

14. The method according to claim 1, comprising:
obtaining a number m first image bands, m>1; and
using pixels in all m first image bands to determine said information.

15. The method according to claim 1, wherein the at least one third image band is different from the at least one second image band.

16. The method according to claim 1, wherein the at least one third image band is the same as the at least one second image band.

17. The method according to claim 1, comprising modifying pixels in all remaining image bands of the image.

18. A method of photocopying an original document having a color background and reducing an amount of color background in a resulting photocopy, the method comprising:
scanning at least one band of said original document to form at least one first image band, said at least one first image band being devoid of printable data;
scanning at least one other band of said original document to thereby form at least one second image band, said at least one second image band having printable data;
determining information from a background color of pixels in said at least one first image band and pixels in a lateral margin portion of said at least one second image band; and
modifying pixel values in at least one third image band based on said information to reduce an amount of color in the resulting photocopy.

19. The method according to claim 18, wherein the determining and modifying steps comprise:
determining a stretch factor based on the information; and
scaling pixel values in the at least one third image band by said stretch factor.

20. The method according to claim 19, wherein the stretch factor depends on at least one peak in a histogram of pixel values that are representative of said pixels in said at least one first image band and said pixels in a lateral margin portion of said at least one second image band.

21. A device capable of photocopying an original document having a color background and reducing an amount of color in a resulting photocopy, the device configured, in a particular operator-selected mode, to:
scan at least one band of said original document to thereby form at least one first image band, said at least one first image band being devoid of printable data;
scan at least one other band of said original document to thereby form at least one second image band, said at least one second image band having printable data;
determine information from a background color of pixels in said at least one first image band and pixels in a lateral margin portion of said at least one second image band; and
modify pixel values in at least one third image band based on said information to reduce an amount of color in the resulting photocopy.

22. The device according to claim 21, wherein the device is configured to:
determine a stretch factor based on the information; and
scale pixel values in the at least one third image band by said stretch factor.

23. The device according to claim 22, wherein the device is configured to determine at least one peak in a histogram of pixel values that are representative of said pixels in said at least one first image band and said pixels in a lateral margin portion of said at least one second image band, to determine said stretch factor.
